(19) United States
(12) Patent Application Publication
(10) Pub. No.: US 2015/0302521 A1
(43) Pub. Date: Oct. 22, 2015

(54) Methods for Enhancing Debt Collection Efficiency

(71) Applicant: Billy Richard Bartmann, Tulsa, OK (US)

(72) Inventor: Billy Richard Bartmann, Tulsa, OK (US)

(21) Appl. No.: 14/751,942

(22) Filed: Jun. 26, 2015

Related U.S. Application Data
(62) Division of application No. 14/075,449, filed on Nov. 8, 2013.
(60) Provisional application No. 61/724,694, filed on Nov. 9, 2012.

(51) Int. Cl. G06Q 40/02

(52) U.S. Cl. CPC G06Q 40/025

(57) ABSTRACT

The methods of this invention solve the problem of low recovery of debt by, prior to recovery of the debt, increasing the debtor's inclination and ability to repay the debt, and only after increasing the debtor's willingness and ability to repay the debt, collecting a greater amount of the debt.

### RELATED APPLICATIONS

This application claims the benefit of U.S. Patent Application 61/724,694, filed on Nov. 9, 2012 and U.S. patent application Ser. No. 14/075,449, filed Nov. 8, 2013.

### BACKGROUND OF THE INVENTION

The business of extending credit and debt collections has existed for hundreds of years and for the most part has remained unchanged throughout its history. The typical debtor has every intention of repaying the debt when purchasing on credit or borrowing funds. However, for various reasons, sometimes within the debtor's control and sometimes beyond the debtor's control, the debtor cannot repay the debt. At some point, the lender resigns itself to taking a loss on the debt and turns to a collection agency to assist with the collection of some portion of the debt.

The term “debt collector” is used interchangeably to describe any business that pursues payment of debts owed by individuals or business. A “collection agency” acts as an agent of the creditor which originally extended the credit (or the original creditor's successor in interest) and usually is compensated by a fee representing a percentage of the amount owed or collected. A debt buyer is a business that purchases the debt from the creditor for cents on the dollar, and then keeps whatever it collects from the debtor. By way of example, if a debtor owes $10,000, the creditor may sell the debt to a debt buyer for $1,000, and the debt buyer manages to get the debtor to pay back $2,000, leaving a $1,000 profit for the debt buyer. Current statistics indicate that for consumer credit card debt, once the debt reaches a debt collector, the rate of recovery is only a fraction of the face value of the debt. For debt purchased by a debt buyer, the rate of recovery is about 2½ to 3 times the amount paid for the debt.

Despite state and federal laws and regulations which govern the activities of debt collectors and prevent egregious conduct, current debt collection strategies have changed little over the years. They follow the basic pattern: Contact the debtor, try to negotiate a lump sum payment or payment plan, and failing that, bring a lawsuit that will likely end with a judgment against the debtor that may or may not be collectable.

A knowledgeable and disciplined debtor may be able to negotiate successfully with a debt collector, but given that a lack of knowledge and discipline may have led to the debtor's financial condition, this is not always a successful strategy. Alternatively, debt settlement and debt counseling services companies promise relief from debt collectors; by way of example, an Internet search for “consumer debt management” generates millions of hits from debt counseling services. However, as the Federal Trade Commission warns, “There is no guarantee that the services debt settlement companies offer are legitimate. There also is no guarantee that a creditor will accept partial payment of a legitimate debt. In fact, if you stop making payments on a credit card, late fees and interest usually are added to the debt each month. If you exceed your credit limit, additional fees and charges also can be added. This can cause your original debt to double or triple. All these fees will put you further in the hole.” In fact, debt settlement companies have a poor reputation for providing value for the fees they charge.

What is lacking with current debt collection strategies is the inherent conflict with the debt collector's goals and an understanding, on the part of the debt collector, of the mindset of the majority of debtors. Further, debt collectors largely have no knowledge of the circumstances that led to the debtor's default or the specific challenges the debtor is facing currently. Most debtors, if given the opportunity, would prefer to repay at least a substantial portion of their debts. However, they lack two things—an inclination to cooperate with the debt collector and an ability to come up with the funds necessary to repay the debt. Current debt collection strategies do nothing to address these deficiencies, and oftentimes work to increase the deficiencies. For example, a debt collector may, subject to laws and regulations, call a debtor repeatedly, demean the character of the debtor, and so on, diminishing the debtor's desire to cooperate. Further, the debt collector may make unreasonable demands for repayment terms that are based on internal policies rather than the debtor's ability to pay, leaving the debtor unable to repay the debt, and increasing the likelihood that the debt collector will take a total or near total loss on the debt.

What is needed, therefore, is a method for collecting debt that increases the debtor's willingness to cooperate with the debt collector and increases the debtor's ability to repay a greater portion of the debt.

### SUMMARY OF THE INVENTION

The methods of this invention solve the problem of low recovery of debt by, prior to recovery of the debt, increasing the debtor's willingness and ability to repay the debt, and only after increasing the debtor's willingness and ability to repay the debt, collecting a recoverable amount of the debt.

By way of example, a debt collector operating according to the inventive methods may have the debtor authorize the debt collector to represent the debtor's interest in negotiations with the debtor's other creditors. Not only does this end the barrage of debt collector phone calls placed to the debtor, the debtor obtains the benefit of the debt collector's expertise in negotiating an advantageous debt settlement. As this has an almost immediate impact, debtor's inclination to pay increases significantly. It also increased the debtor's ability to pay by reducing the amount the debtor owes to his or her other creditors. Further, by way of example, a debt collector operating according to the inventive methods helps the debtor find employment or get better employment. The debt collector can do this by creating a more persuasive resume, identifying potential job openings, and coaching the debtor on job interview skills. This acts both to increase the debtor's inclination to pay as well as potentially increasing the debtor's ability to pay. Further, by way of example, a debt collector operating according to the inventive methods helps the debtor apply for governmental programs or private social programs for which the debtor may be eligible. If the debtor can obtain a temporary stream of income from a governmental program or address a housing or nutritional deficiency, the debtor will have more resources to pay the debt, and therefore has an increased ability to pay. Once the forgoing actions have been substantially or fully completed, the debtor has an increased inclination and ability to pay. The debt collector can then prepare a repayment plan commensurate with the debtor's enhanced ability to pay. Further, by way of example, a debt collector operating under the inventive methods helps the debtor identify legal counsel in cases where the debtor has been sued by a creditor or where a creditor has violated federal or state laws regarding debt collection. The delivery of services under the inventive methods works to build a trust relationship between the debt collector and the debtor. The debt collector who provides services that improve the debtor's quality of life will recognize a significant positive impact on the debtor's willingness to pay as the debtor comes to appreciate and develop a sense of obligation to the debt collector.

While in the prior art, others—such as for-profit and non-profit businesses as well as government agencies—have provided similar portions of the inventive methods, none offer all elements of the inventive methods. For example, a private or government social program may help the debtor find employment, a separate legal aid organization may help the debtor in collection lawsuits brought by creditors, and a separate charity may offer discounted medical care. Further, for those service providers that assist with debt repayment, not all will have a financial stake in the outcome of the provision of the services—they may be compensated through grants, donations, or fees paid directly by the debtor, irrespective of the ultimate outcome of the debtor's circumstances. Some unscrupulous debt settlement companies demand several months of advance payments from the debtor before ever commencing debt negotiations; if the debtor pays some, but not all of the advance payments, the debt settlement company keeps the advance payment without providing any services whatsoever.

In contrast, a debt collector, following the methods disclosed in this application, offers the debtor with the full menu of services associated with the inventive methods free of charge or at a charge less than the debt collector's cost of providing the service, with the debt collector absorbing the expenses as a cost of doing business. The inventor has found through application of the inventive methods that the rate of net debt reparation has increased on average, by approximately 100% (from 2½ to 3 times the purchase price of the debt to over 5 times the purchase price of the debt.). As an additional benefit, the inventor has also found that through application of the inventive methods, a relationship based on trust is created and a debt collector operating according to the inventive methods receives fewer consumer complaints—a happy debtor is less likely to blame the collection agency or original creditor for financial difficulties. This can enhance the public reputation of both the debt collector and the original creditor. Further, once the debtor has successfully repaid the debt, the former debtor, having enjoyed the benefit of a trusting relationship, is more likely to turn to the debt collector for advice and guidance on a wide range of financial and non-financial products. Often, the debtor may turn to the original creditor for future financing needs and the creditor is more likely to be willing to extend credit to the former debtor, knowing that the former debtor is now better equipped to manage debt.

### BRIEF DESCRIPTION OF THE DRAWINGS

FIG. 1 is a flow chart showing the initial intake of a new case.

FIG. 2 is a flow chart showing the overview of an alternative debt collection pathway applicable to certain debtors.

FIG. 3 is a flow chart showing the overview of the inventive service.

FIGS. 4a and 4b is a flow chart showing the details of the debt negotiation and settlement services portion of the inventive service.

FIG. 5 is a flow chart showing the details of the provision of social services portion of the inventive service.

FIGS. 6a and 6b is a flow chart showing the details of the provision of career services portion of the inventive service.

FIG. 7 is a flow chart showing the details of the litigation referral services portion of the inventive service.

FIG. 8 is an example of a communication from a debt collector using the inventive service to a debtor following initial intake.

FIG. 9 is an example of the Letter of Representation Consent Form signed by a debtor under the inventive service.

FIG. 10 is an example of a letter sent to a debtor's creditors by a debt collector under the inventive service.

### DETAILED DESCRIPTION OF THE INVENTION

While the invention is susceptible of embodiments in many different forms, there is shown in the drawings and will herein be described in detail several possible embodiments of the invention with the understanding that the present disclosure is to be considered as an exemplification of the principles of the invention and is not intended to limit the broad aspects of the invention to the embodiments illustrated as relates to the various types of debts that the debt collector would collect under the inventive method or the relationship between the debt collector and the owner of the particular type of debt.

Initial Contact

The purpose of the initial contact between the debtor and debt collector is to inform the debtor of the identity of the debt collector and the creditor it represents (if any), to make certain legally-required disclosures to the debtor, and to begin the process of negotiating reparation. However, a debt collector operating according to the inventive methods will use this initial contact with the debtor to establish a non-adversarial relationship between the debtor and debt collector. Initial contact can come in the form of any of a variety of traditional communications mechanisms, including but not limited to telephonic, mail or internet.

In other embodiments, debtors may be contacted by mail, via the debt collector's website or by other electronic means. In each case, the objective is to incentivize the debtor to establish telephonic communication so that the intake interview and associated explanation of no cost services available may be had. It is possible to communicate and establish a relationship with the debtor solely by mail or electronic means.

Letter of Representation

Debt collectors hired by creditors may strictly follow state and federal regulations, they may be exploiting grey areas in those regulations, or they may be ignoring those regulations altogether. At best, the debtor is merely overwhelmed by the volume of legitimate phone calls and letters, and at worst, the debtor is receiving harassing and intimidating phone calls and letters.

Under federal law, a debtor has the right to inform a debt collector that he or she is represented by an attorney, and once the debt collector is on notice of this representation, the debt collector may no longer contact the debtor directly, but instead must contact the attorney. A debtor also has the right to inform the debt collector that he or she is represented by a non-attorney third party representative, and once the debt collector is on notice of this representation, the debt collector will by custom, rather than law, observe the debtor's wishes and contact only the third party representative. A debt collector operating according to the inventive methods may have the debtor execute a Letter of Representation that is a form of consent and designation of authorized representative authorizing the debt collector to represent the debtor's interest in negotiations with the debtor's other creditors. Once obtained, the debt collector sends the Letter of Representation and designation of authorized representative to the other creditors informing them that they can no longer contact the debtor concerning the outstanding obligation, but instead must contact the debt collector agency.

The immediate benefit to the debtor is the cessation of the harassing phone calls from a number of debt collectors that may or may not be following state and federal regulations.

In other embodiments, the debt collector may advise the Client to seek bankruptcy counsel or the services of an accredited credit counseling agency or a debtor rights attorney to pursue claims against a creditor for violations of state or federal law.

Debt Settlement Negotiation

The debt collector contacts each of the respective creditors of the debtor and begins to negotiate on behalf of the debtor. Because the debt collector is skilled and a more experienced negotiator, typically it can better communicate the debtor's financial situation and thus effectuate a larger discount or a structured payment plan that the debtor could have obtained if acting alone. The resulting restructuring of the debtor's obligations results in improving the debtor's cash flow and financial position, thus improving both willingness and ability to repay the debt collector.

Debtor Employment

Even with an increased inclination to pay, a debtor cannot begin reparation of a debt without money, and in many cases, the debtor is unemployed or under-employed. There are many causes of un- and under-employment, including seasonal shifts, downturns in the economy, injury/illness, lack of qualifications, and so on. A debt collector cannot repair a sluggish economy or a bad back, however, for a majority of debtors, a debt collector operating according to the inventive methods can take a number of actions that will enhance the employability of the debtor.

In the course of establishing a relationship with the debtor, the debt collector will obtain background and employment history from the debtor. The debt collector then prepares a professional resume for the debtor. The debt collector sends this resume back to the debtor for his or her own use, and also sends the resume off to Internet job posting sites, such as Monster.com, LinkedIn, CareerBuilder, HotJobs, and CraigsList.

Further, the debt collector may perform Internet searches for employment that match the skill set and education level of the debtor. Once such an opening is identified, the debt collector obtains permission from the debtor to prepare a job application on behalf of the debtor. When the job application is completed, the debt collector sends it along with the previously prepared resume to the prospective employer. The debt collector may then follow-up with the prospective employer to arrange an interview for the debtor. Once the interview time is set, the debt collector counsels the debtor on interview skills and dress.

Further, the debt collector may provide additional counseling to the debtor to enhance the debtor's employability. By way of example and not limitation, this could include advising the debtor on interview skills, conducting mock interviews, and advising the debtor on proper interview attire.

In other embodiments, the debt collector may counsel the debtor on opportunities to improve job skills or other locations across the country where the debtor's existing skills may be in higher demand.

Government and Private Social Program Benefits

Many debtors whose financial circumstances have put them in a place where they are now being pursued by debt collectors are also eligible for a number of governmental programs on the federal, state and local level, such as Social Security, Medicare/Medicaid, Food Stamps, transportation, and child care. However, many debtors are not familiar with the eligibility requirements for these programs, and others find themselves overcome by the often-confusing application processes. A debtor who can take advantage of these governmental programs may spend less of his or her paycheck on food, medicine, housing, and the like, resulting in more of the paycheck being available to repay the debt.

In the course of establishing a relationship with the debtor, the debt collector operating according to the inventive methods will obtain detailed information about the debtor's assets, liabilities, income, and expenses. With this information, the debt collector will be able to determine the debtor's eligibility for various government and private social programs and will be able to assist the debtor in completion and submission of the appropriate applications.

By way of example and not limitation, the governmental social programs include Social Security disability, Social Security Supplemental Income, Medicaid, Supplemental Nutrition Assistance Program, unemployment benefits, education and job training, and housing assistance. In the course of establishing a trust relationship with the debtor, the debt collector operating according to the inventive methods may provide life coaching and success skills. Often, debtors who have lost employment or are behind on their bills will experience a low self-esteem. The debt collector can provide resources in the form of teleseminars, CDs/DVDs, workbooks and other literature to help the debtor to see themselves other than as victims. Recovering from a setback begins with the debtor seeing themselves as a worthwhile individual and successful.

By way of example and not limitation, private social programs include temporary housing shelters, food banks, discount prescription coupons, utility assistance, Salvation Army and other United Way or charitable agencies and non-profit credit counseling. Sometimes, a debtor's situation has deteriorated to the point that food and housing is a challenge, although more commonly, the debtor may need assistance with prescription medicines and dental care. The debt collector can provide the debtor with guidance in locating the most applicable private social programs based on the debtor's particular circumstances.

Litigation Referral

In the course of establishing a relationship with the debtor, the debt collector operating according to the inventive methods will obtain detailed information about the debtor's other debts, including those creditors who may litigate with the consumer and those creditors who may have violated state or federal collection laws.

By way of example and not limitation, referral of the debtor to knowledgeable legal resources who may provide representation to the debtor is of high value to the debtor and enhances the debtor's willingness and ability to repay the debt.

### An Embodiment of the Inventive Methods

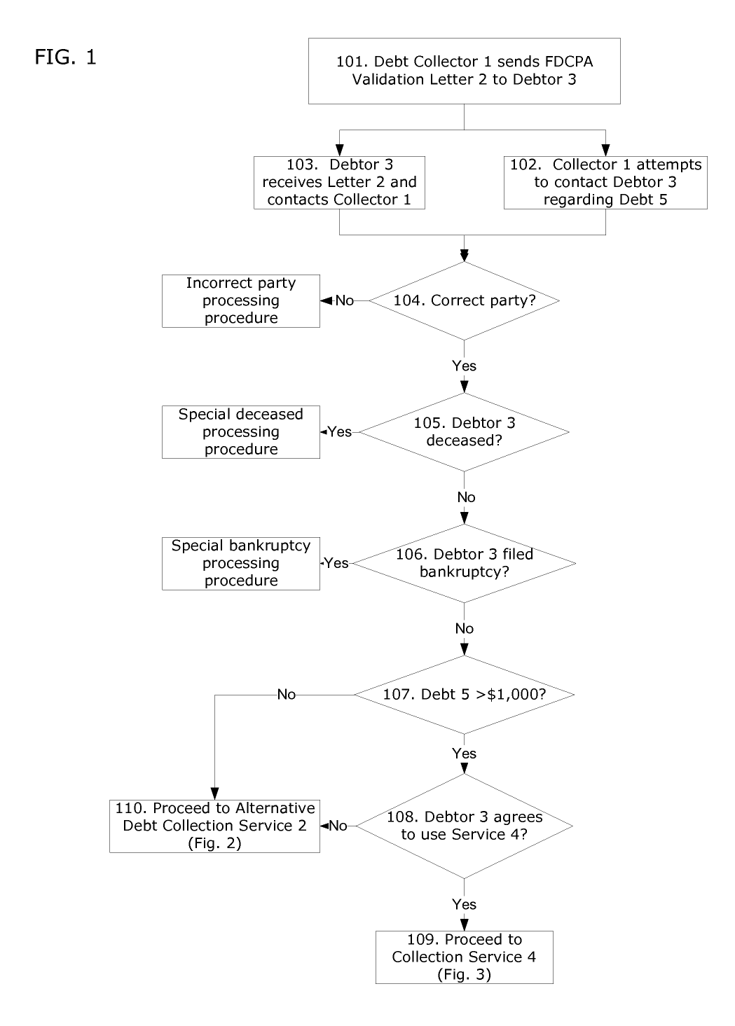

FIG. 1 shows Debt Collector l′s intake of new Debt 5 owed by Debtor 3. Debt Collector 1 will have some information about Debtor 3 and Debt 5; by way of example and not limitation, if a creditor has sold Debt 5 to Debt Collector 1, the creditor may provide the name, address, phone number, and specific information about Debt 5. In steps 101 and 102, Debt Collector 1 sends the mandatory FDCPA Validation Letter to Debtor 3 and attempts to make contact with Debtor 3 by phone. As shown in step 103, Debtor 3 may self-respond to Debt Collector 1. As shown in steps 104-108, during this initial call, Debt Collector 1 makes some initial inquiries to confirm the applicability of inventive Collection Service 4; Debt Collector 1 may also explain the debt collection process, including an overview of Collection Service 4, to Debtor 3. If Collection Service 4 is inapplicable to Debtor 3 (for example, if Debtor 3 has filed bankruptcy or is deceased), then Debt Collector 1 utilizes special processing procedures unique for that situation. Otherwise, Debt Collector 1 proceeds to collect the debt using traditional debt collection techniques which are outside of the scope of this invention.

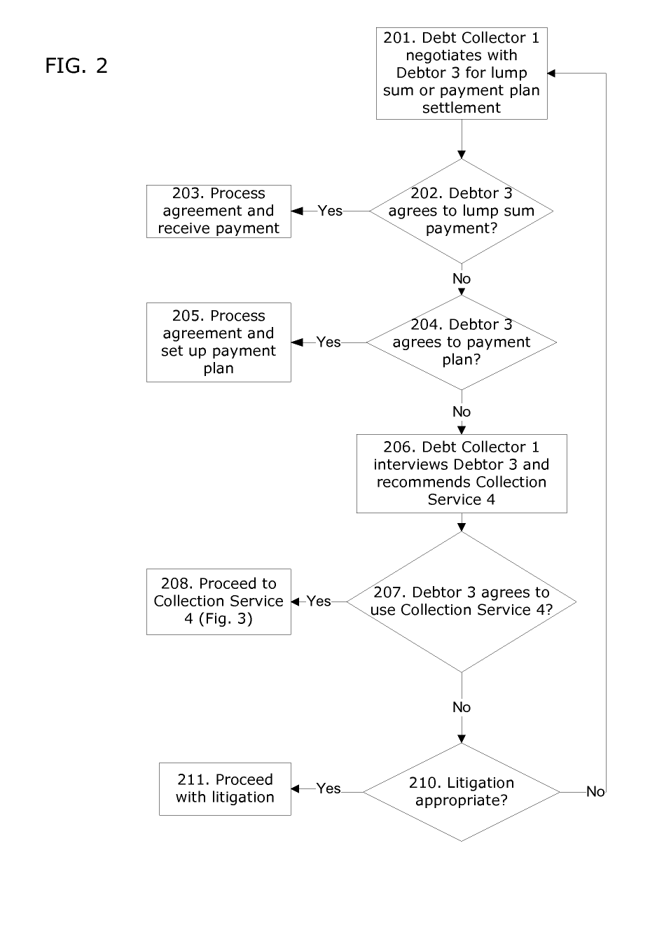

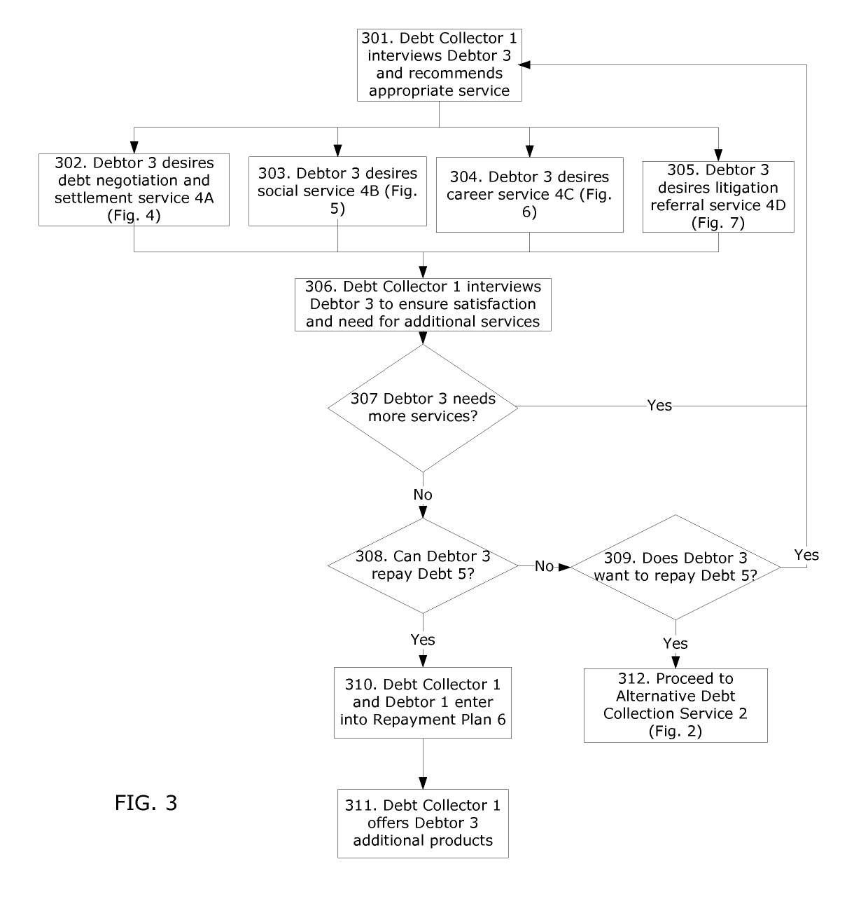

As shown in step 107, if the amount of the debt is less than a minimal amount (in this case, $1,000), it may be more appropriate for both Debtor 3 and Debt Collector 1 to initially pursue collection through a more traditional Alternative Debt Collection Service 2. As shown in FIG. 2, Collection Service 2 begins with more traditional collection steps—negotiating either a lump sum settlement (step 202) or a payment plan (step 204). However, if Debtor 3 remains unable to repay, then Debtor 3 and Debt Collector 1 may agree to proceed with inventive Collection Service 4. If Debtor 3 does not agree to use Collection Service 4, then Debtor 3 will remain in Collection Service 2 until Debt 5 is resolved, either through settlement, write-off, or litigation.

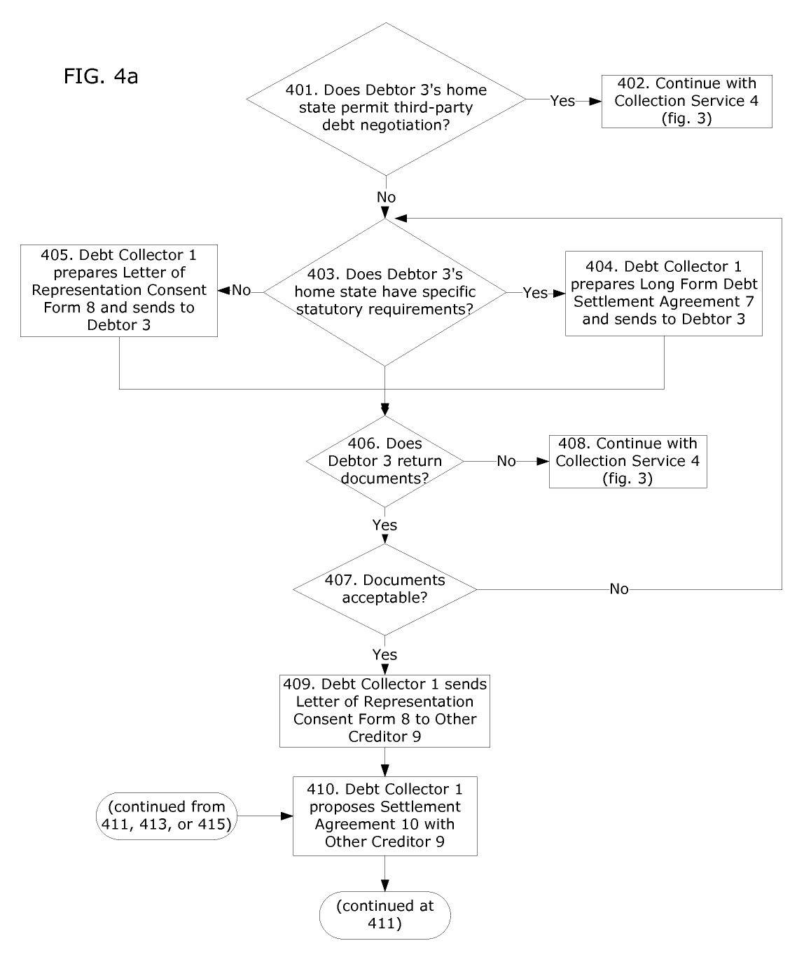

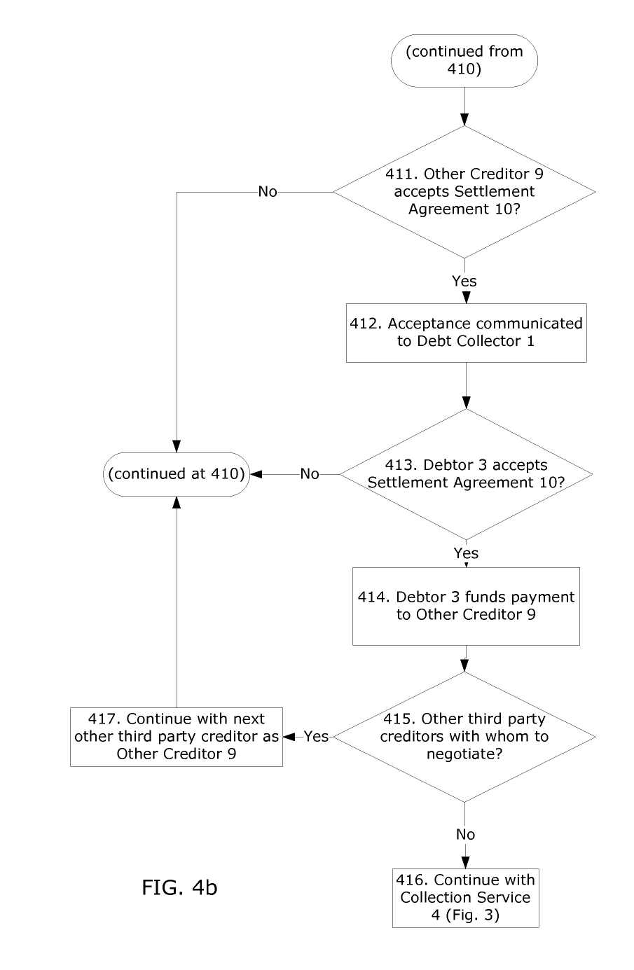

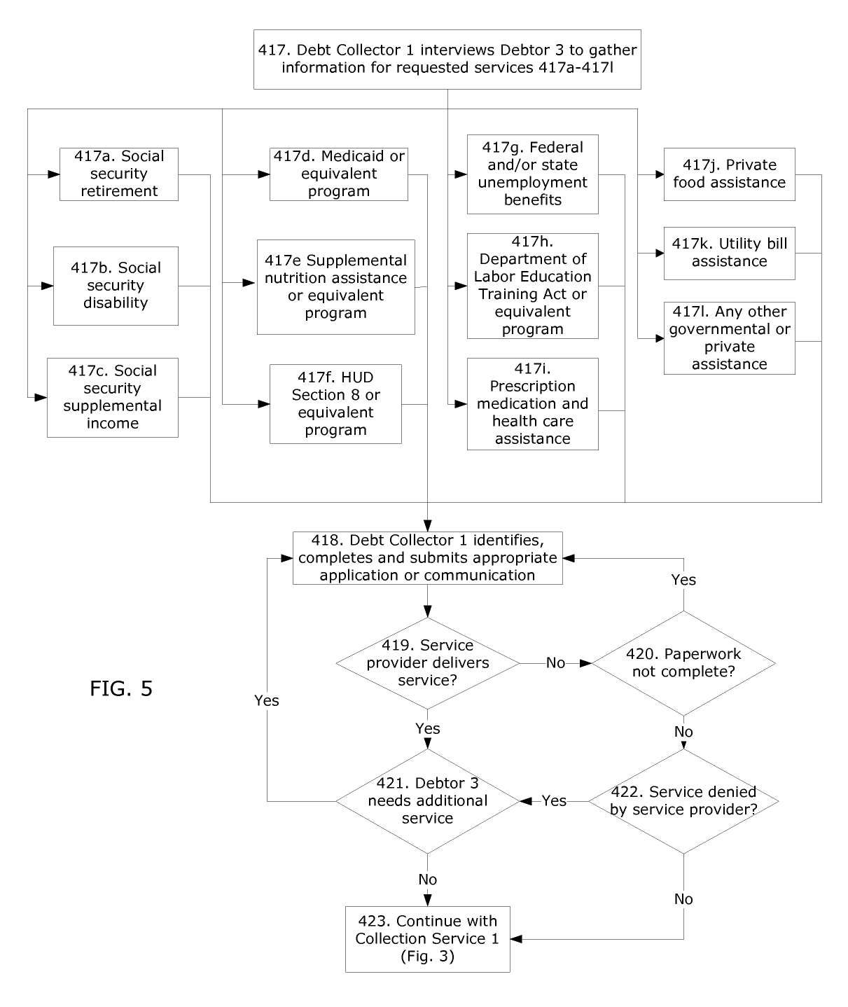

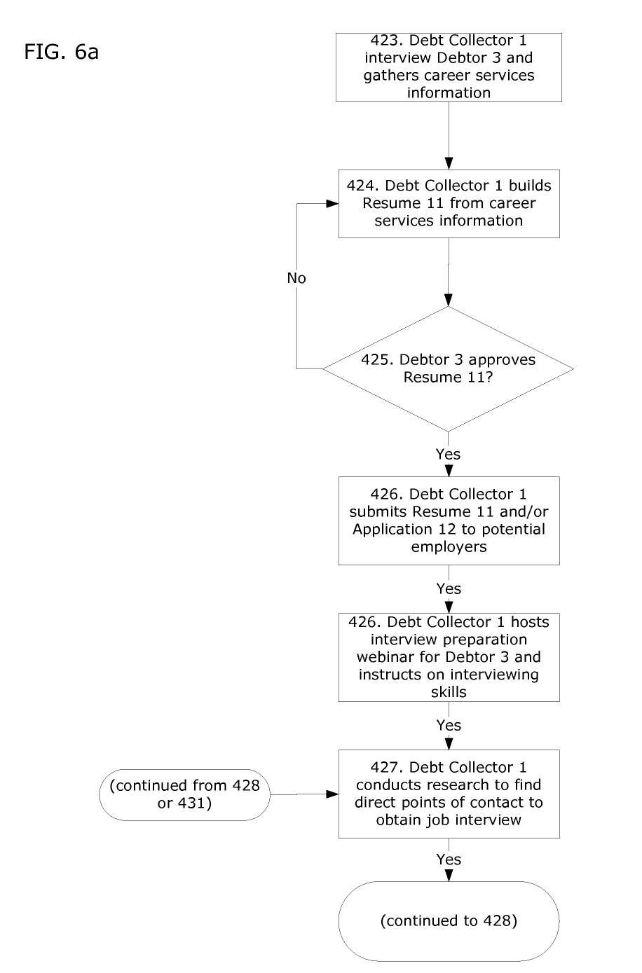

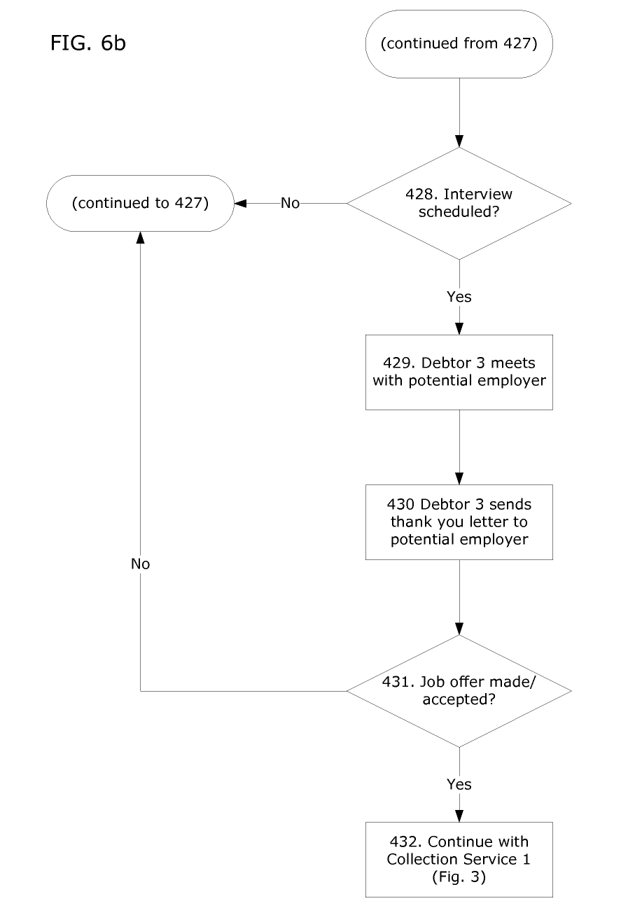

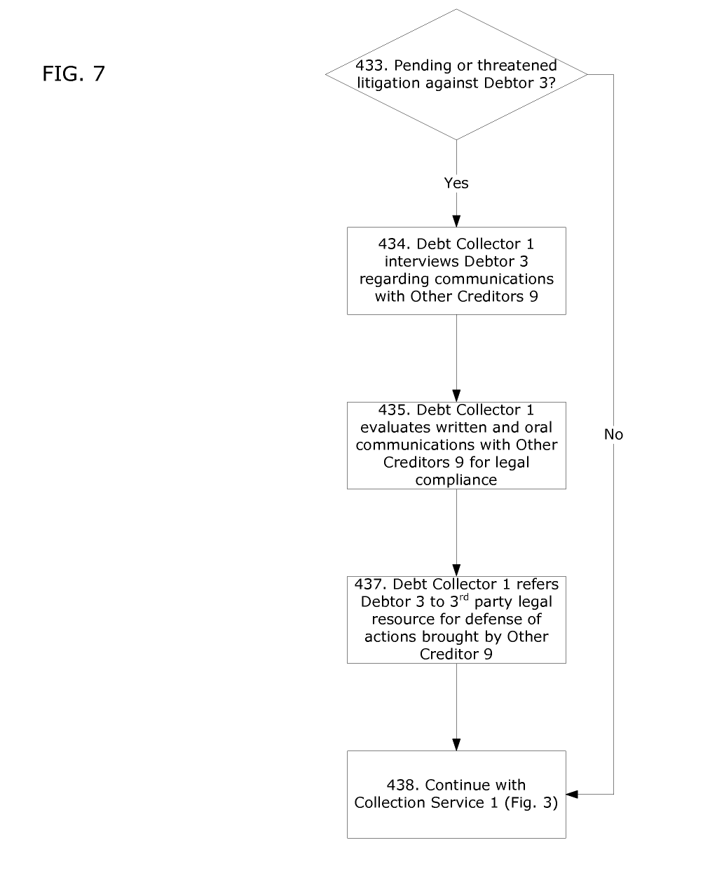

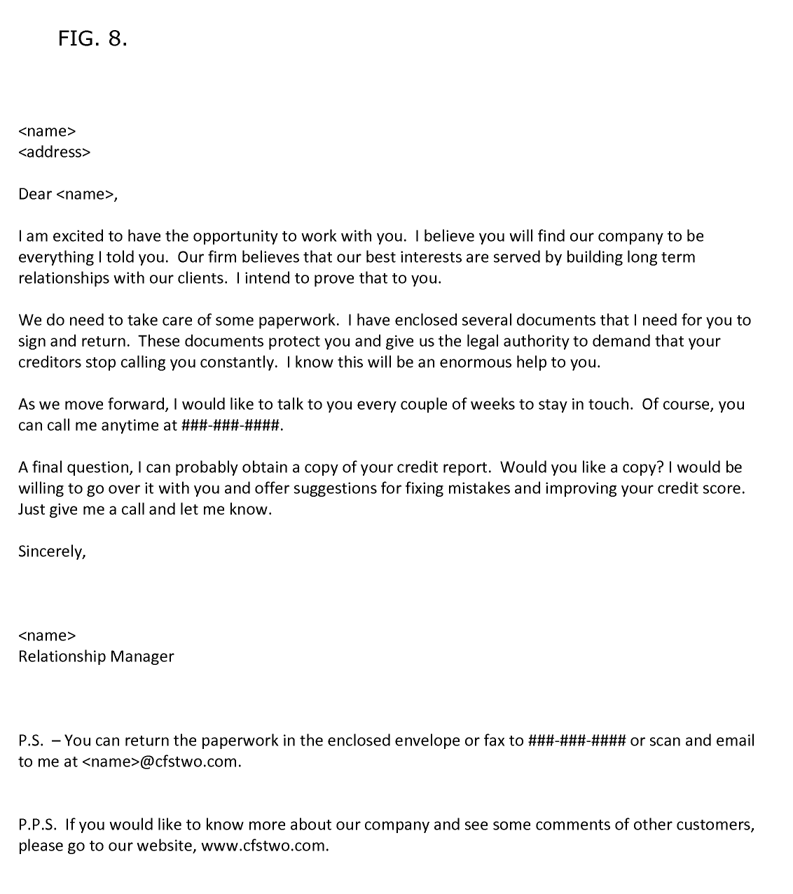

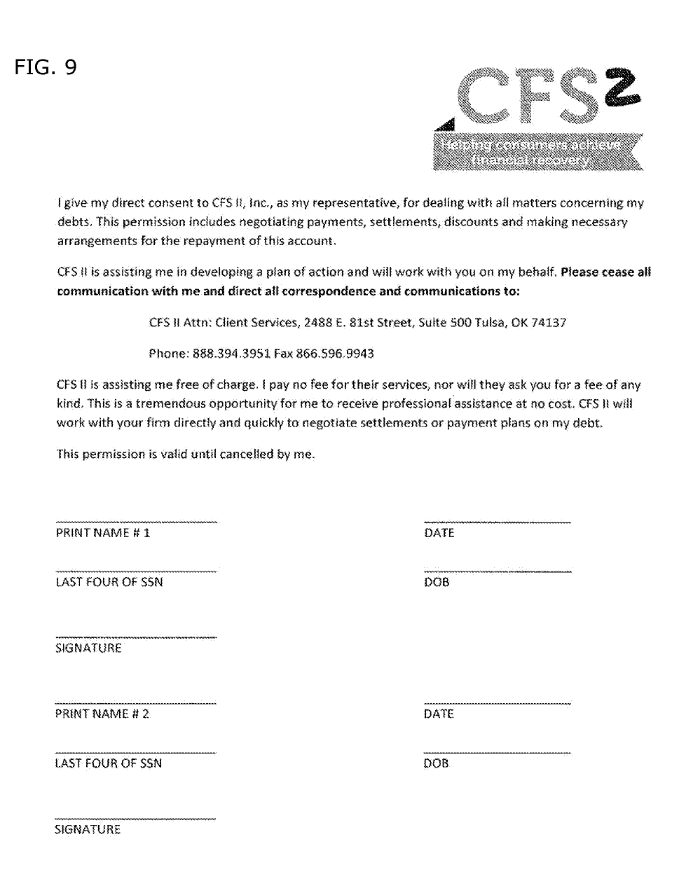

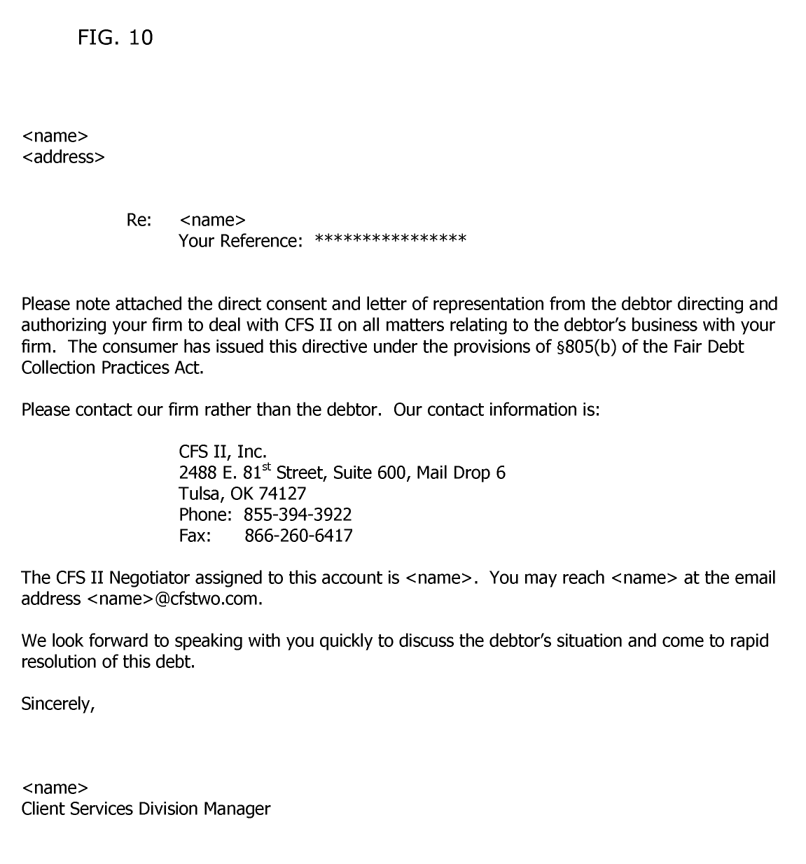

FIGS. 3-7 show of the inventive Collection Service 4, which begins in step 301 with an interview of Debtor 3. The purpose of this interview is to determine which of the specific components of Collection Service 4 are applicable to Debtor 3. During step 301, Debt Collector 1 may fill out worksheets and interview forms, and at the end of the initial interview, Debt Collector 1 will recommend specific elements of the inventive Collection Service 4. The various elements of Collection Service 4 may require Debt Collector 1 to send to Debtor 3 various consent forms, disclosures, questionnaires, lists of other creditors and status of other debt, asset/liability worksheets, income expense worksheets, and where necessary under state law, a contract agreement or a letter of representation; some states may have additional documentation requirements and some states simply do not allow debt negotiation by a licensed collection agency. Debtor 3 completes and returns various authorization documents, consents, and information forms as are required for the specific collection service(s) utilized. FIG. 8 shows an example cover letter sent to Debtor 3 regarding Collection Service 4. FIG. 9 shows a sample consent form executed by Debtor 3 that authorizes Debt Collector 1 to deal directly with other creditors of Debtor 3 in the delivery of Collection Service 4. FIG. 10 shown a sample letter to Debtor 3's other creditors in the delivery of Collection Service 4. In steps 204-207, Debt Collector 1 provides Debt Negotiation and Settlement Services 4A, Social Services 4B, Career Services 4C, and/or Litigation Referral Services 4D. Note that depending on Debtor 3's particular situation, Debt Collector 1 may not provide all of these services. Further note that there is no particular sequential order in the provision of these services, and in fact provision of services may overlap.

After the provision of the applicable services, Debtor 3 should be in a position to repay some or all of Debt 5, and Debtor 3 will enter into a Repayment Plan 6 with Debt Collector 1. Debtor 3 may be in an improved financial situation such that Debtor 3 may be interested in purchasing various financial-related products from Debt Collector 1. If Debtor 5 does not successfully complete Debt Negotiation and Settlement Services 4A, Social Services 4B, Career Services 4C, and/or Litigation Referral Services 4D, or if Debtor 5 is otherwise unable to repay Debt 5, Debt Collector 1 will attempt to collect the debt using traditional debt collection techniques which are outside of the scope of this invention.

FIG. 3 shows the details of Debt Negotiation and Settlement Services 4A. This service begins with Debt Collector 1 determining the eligibility of Debtor 3 under state law governing the provision of debt negotiation and settlement services by Debt Collector 1. Once eligibility of Debtor 3 is determined, Debt Collector may send a Long Form Debt Settlement Agreement 7 and/or Letter of Representation Consent Form 8 to Debtor 3. (Some states require a written services agreement which includes a letter of representation. See, e.g., TEX. FIN. CODE ANN. §394.209; CAL. Civ. CODE §1789.16.) FIG. 9 shows an example of Letter of Representation Consent Form 8. After Debtor 3 has returned Contract Agreement 7 and Consent Form 8, Debt Collector 1 contacts each Other Creditor 9 to inform Other Creditor 9 that Debt Collector 1 is authorized to negotiate on behalf of Debtor 3. FIG. 10 shows an example of a letter to Other Creditor 9. Debt Collector 1 negotiates with each Other Creditor 9 until they come up with a Settlement Agreement 10 that is acceptable to Debtor 3.

FIG. 5 shows the details of Social Services 4B. Because Debt Collector 1 has obtained detailed information about Debtor 3's finances, age, and health, and is in a position to determine the likelihood that Debtor 3 may be eligible for various governmental or private social services. As shown in steps 417-422, these services include (but are not limited to) Social Security Retirement Benefits, Medicare, Social Security Disability Insurance, Social Security Supplemental Income, Medicaid, Supplemental Nutrition Assistance Program (or a state/local equivalent), HUD Section 8 housing (or a state/local equivalent), state or federal unemployment benefits, or Department of Labor Education Training Act programs (or a state/local equivalent) assistance with prescription medicines and health care, private food assistance, and assistance with utility bills. Depending on requirements of a particular program, Debt Collector 1's services may include counseling Debtor 3 on the program requirements, sending forms to Debtor 3, and/or preparing program applications, in whole or in part, on behalf of Debtor 3.

FIG. 6a and FIG. 6b shows the details of Career Services 4C. This service begins with Debt Collector 1 collecting information about Debtor 3's work history, education, training, availability, and any physical work limitations. Based either on an existing resume provided by Debtor 3, or starting from scratch, Debt Collector 1 prepares Resume 11. After confirming the accuracy of Resume 11 with Debtor 3, Debt Collector 1 researches the job marked based on Debtor 3's geographic location and qualifications. Based on this research, Debt Collector 1 may post Resume 11 on various job search web sites and/or on specific employer job web sites. Debt Collector 1 works with Debtor 3 to identify any job interview opportunities that may be available. Debt Collector 1 may assist Debtor 3 with preparation and submission of one or more Application 12. If opportunities are available, Debt Collector 1 (or Debtor 3) schedule interview(s), and Debt Collector 1 coaches Debtor 3 on job interview skills and conducts mock interviews to ensure the Debtor 3 is prepared for the job interview.

FIG. 7 shows the details of Litigation Referral Service 4D. If any Other Creditor 9 is threatening litigation or has already initiated litigation against Debtor 3 for other debt, Debt Collector 1 counsels Debtor 3 on Debtor 3's rights and Other Creditor 9 obligations on collection activities. Debt Collector 1 may also counsel Debtor 3 on requirements for documenting improper collection activities which may violate state or federal collection laws. If litigation is threatened or pending, Debt Collector 1 may refer Debtor 3 to qualified third-party counsel for defense of Debtor 3. Further, if there have been improper collection activities, Debt Collector 1 may refer Debtor 3 to qualified third-party counsel for bringing an action against Other Creditor 9.

### Other Embodiments

The preferred embodiment shown in FIGS. 1-10 is but one of a number of embodiments based on the inventive methods of this patent. Other embodiments of this inventive methods of this patent may vary on specific details, however, so long as the embodiment does not depart from the spirit of the invention, which solves the problem of low recovery of debt by, prior to recovery of the debt, increasing the debtor's willingness and ability to repay the debt, and only after increasing the debtor's willingness and ability to repay the debt and establishing a relationship based on trust, collecting a greater recoverable amount of the debt.

Further, the embodiments of the inventive methods have been described from the perspective of “Debt Collector 1,” a term which as used here refers generally to any business—for example, an original creditor, a successor to the original creditor, a third-party debt collector, a debt buyer, or a government agency—that pursues payment of debts owed by individuals or businesses. However, subject to regulatory restrictions, these same inventive methods can be customized to apply to any entity attempting to recover a debt owed, whether that debt originated from a financed purchase, an unsecured loan, a monetary fine, a one-time or recurring payment, or virtually any other legal obligation to pay.

1. A method of debt collection, comprising the steps:
a debt collector conducting an interview of a debtor regarding a debt owed by the debtor to a creditor;
the debt collector determining the debtor's eligibility for a social program;
the debt collector assisting the debtor with obtaining benefits from the social program; and
the debt collector negotiating with the debtor for repayment of the debt.

2. The method of claim 1, where:
where the social program is offered by a government entity.

3. The method of claim 1, where:
the social program is offered by a non-government entity.

4. The method of claim 1, where:
the debt collector is the creditor.

5. The method of claim 1, where:
the debt collector is a third-party debt collector.

6. The method of claim 1, where:
the debt collector is a debt buyer.

7. The method of claim 1, where:
the debt collector is a governmental entity.
